(19) United States
(12) Patent Application Publication
(10) Pub. No.: US 2024/0136611 A1
(43) Pub. Date: Apr. 25, 2024

(54) BATTERY AND ELECTRONIC DEVICE

(71) Applicant: ZHUHAI COSMX BATTERY CO., LTD., Zhuhai (CN)

(72) Inventors: Fan YANG, Zhuhai (CN); Jian ZHANG, Zhuhai (CN); Kongyan XIE, Zhuhai (CN); Chong PENG, Zhuhai (CN)

(73) Assignee: ZHUHAI COSMX BATTERY CO., LTD., Zhuhai (CN)

(21) Appl. No.: 18/400,373

(22) Filed: Dec. 29, 2023

Related U.S. Application Data
(63) Continuation of application No. PCT/CN2022/131854, filed on Nov. 15, 2022.

(30) Foreign Application Priority Data
Dec. 14, 2021 (CN) 202111542585.6

(51) Int. Cl. H01M 10/63; H01M 10/44; H01M 10/615; H01M 10/623; H01M 50/531; H02J 7/00

(52) U.S. Cl. CPC H01M 10/63; H01M 10/443; H01M 10/615; H01M 10/623; H01M 50/531; H02J 7/0047; H01M 2220/30

(57) ABSTRACT

Disclosed are a battery and an electronic device, where the battery includes a first electrode plate, a second electrode plate, a control unit, and a first tab and a second tab that are connected to the first electrode plate, and the first electrode plate and the second electrode plate have opposite polarities. The control unit includes a heating control circuit, and in a case that the battery is connected to an external power supply, the heating control circuit is configured to: when a battery temperature of the battery is less than a first temperature threshold, conduct the first tab, the first electrode plate, and the second tab to heat the battery. A charging speed of the battery at a low temperature may be improved, and lithium deposition and capacity fading of the battery may be slowed down.

### CROSS-REFERENCE TO RELATED APPLICATIONS

The present disclosure is a continuation of International Application No. PCT/CN2022/131854, filed on Nov. 15, 2022, which claims priority to Chinese Patent Application No. 202111542585.6, filed on Dec. 14, 2021. All of the aforementioned patent applications are hereby incorporated by reference in their entireties.

### TECHNICAL FIELD

Embodiments of the present disclosure relate to the field of battery technologies, and in particular, to a battery and an electronic device.

### BACKGROUND

Nowadays, lithium-ion batteries are increasingly widely used and have been applied in more and more occasions. However, there are some problems when a lithium-ion battery at a relatively low temperature is used, including capacity fading and low charging/discharging efficiency, and even a problem of deposition of metal lithium at a position of a negative electrode may be caused when the lithium-ion battery at a relatively low temperature is used.

In related technologies, there are many solutions to problems that a battery at a low temperature has a slow charging speed, and lithium deposition easily occurs for a battery at a low temperature for a long time, for example, self-exothermic heating; bidirectional pulse heating, that is, dividing a battery pack into two groups of batteries of equal capacity, and exchanging power between the two groups of batteries, to heat the battery by using an internal resistance; alternating current heating, that is, heating a battery by using alternating current; a heating method in which a battery drives an electric heating wire and cooperates with a fan for heating; and the like.

However, neither of the foregoing solutions can better solve problems that a battery at a low temperature has a slow charging speed, and lithium deposition easily occurs for a battery at a low temperature for a long time.

### SUMMARY

Embodiments of the present disclosure provide a battery and an electronic device, to solve technical problems that a battery at a low temperature has a slow charging speed and capacity fading, and lithium deposition easily occurs for a battery at a low temperature for a long time.

The embodiments of the present disclosure provide the following technical solutions to solve the foregoing technical problems.

According to one aspect, an embodiment of the present disclosure provides a battery, which includes a first electrode plate, a second electrode plate, a control unit, and a first tab and a second tab that are connected to the first electrode plate. The first electrode plate and the second electrode plate have opposite polarities. The control unit includes a heating control circuit, and in a case that the battery is connected to an external power supply, the heating control circuit is configured to: when a battery temperature of the battery is less than a first temperature threshold, conduct the first tab, the first electrode plate, and the second tab, so that current flowing into the battery flows through the heating control circuit, the first tab, the first electrode plate, and the second tab, to heat the battery, so that the battery is in a heating state.

In a possible implementation, the battery further includes a third tab connected to the second electrode plate. The control unit further includes a charging control circuit, and in a case that the battery is connected to the external power supply, the charging control circuit is configured to: when the battery temperature is greater than or equal to the first temperature threshold, charge the battery. The charging control circuit is connected to the third tab, and is also connected to at least one of the first tab and the second tab.

In a possible implementation, the first temperature threshold ranges from 5° C. to 20° C.

In a possible implementation, the control unit further includes a controller, a detection subunit connected to the controller, and a temperature sensor connected to the detection subunit. The detection subunit is configured to: receive a battery temperature detected by the temperature sensor, and feed back the battery temperature to the controller. The controller is configured to determine, based on the battery temperature fed back by the detection subunit, the battery temperature is less than the first temperature threshold or greater than or equal to the first temperature threshold.

In a possible implementation, in a case that the battery is in the heating state, and a controller of the control unit determines that the battery temperature is greater than or equal to the first temperature threshold, the controller controls the heating control circuit to be open and the charging control circuit to be closed.

In a possible implementation, the temperature sensor is configured to collect at least one of a temperature of the first tab, a temperature of the second tab, a temperature of the third tab, and a temperature of a surface of the battery.

In a possible implementation, a controller of the control unit is further configured to acquire a battery capacity. When the battery capacity is greater than or equal to a first capacity threshold, the controller controls the charging control circuit and the heating control circuit to be open.

In a possible implementation, the first capacity threshold ranges from 95% to 100%.

In a possible implementation, a resistance corresponding to a portion, located between the first tab and the second tab, of the first electrode plate is greater than or equal to 4 milliohms.

In a possible implementation, a sum of a resistance of a position where the first tab and the first electrode plate are connected and a resistance of a position where the second tab and the first electrode plate are connected is R1. The resistance corresponding to the portion, located between the first tab and the second tab, of the first electrode plate is R, where R1/R≤40%.

In a possible implementation, projections of the first tab, the second tab, and the third tab in a thickness direction of the battery do not overlap.

According to another aspect, an embodiment of the present disclosure provides an electronic device, which includes a battery. The battery includes a first electrode plate, a second electrode plate, a control unit, and a first tab and a second tab that are connected to the first electrode plate, and the first electrode plate and the second electrode plate have opposite polarities. The control unit includes a heating control circuit, and in a case that the battery is connected to an external power supply, the heating control circuit is configured to: when a battery temperature of the battery is less than a first temperature threshold, conduct the first tab, the first electrode plate, and the second tab, so that current flowing into the battery flows through the heating control circuit, the first tab, the first electrode plate, and the second tab, to heat the battery, so that the battery is in a heating state.

Beneficial effects of the embodiments of the present disclosure are as follows: according to the battery provided in the embodiments of the present disclosure, a first tab and a second tab are disposed on a first electrode plate, and when a battery temperature is less than a first temperature threshold, a heating control circuit conducts the first tab, the first electrode plate, and the second tab, so that current flowing into the battery flows through the first tab, the first electrode plate, and the second tab. In this case, the battery may be heated by using ohmic heat generated by the first tab, the first electrode plate, and the second tab, so that a temperature of the battery increases. This may effectively solve problems that a battery at a low temperature has a slow charging speed and capacity fading, and lithium deposition easily occurs for a battery at a low temperature for a long time. In other words, the battery provided in the embodiments of the present disclosure may improve a charging speed of the battery at a low temperature, and slow down lithium deposition and capacity fading.

### BRIEF DESCRIPTION OF THE DRAWINGS

Accompanying drawings herein included in this specification and constituting a part of this specification illustrate embodiments conforming to the present disclosure, and are intended to explain the principles of the present disclosure together with this specification.

FIG. 1 is a schematic diagram of a battery according to Embodiment 1.

FIG. 2 is a schematic cross-sectional diagram of a battery cell according to Embodiment 1.

FIG. 3 is a schematic cross-sectional diagram of an unwound positive electrode plate according to Embodiment 1.

FIG. 4 is a schematic diagram of a battery according to Embodiment 2.

FIG. 5 is a schematic cross-sectional diagram of a battery cell according to Embodiment 2.

FIG. 6 is a schematic cross-sectional diagram of an unwound negative electrode plate according to Embodiment 2.

Embodiments of the present disclosure are illustrated in the foregoing accompanying drawings, and will be described in more detail later. These accompanying drawings and descriptions are not intended to limit the scope of the present disclosure in any way, but to describe the concept of the present disclosure for a person skilled in the art with reference to specific embodiments.

### DETAILED DESCRIPTION OF THE EMBODIMENTS

Exemplary embodiments will be described in detail herein, and examples thereof are shown in the accompanying drawings. When the following description refers to the accompanying drawings, unless otherwise indicated, a same reference numeral in different drawings indicates a same or similar element. Implementations described in the following exemplary embodiments do not represent all implementations consistent with the present disclosure. On the contrary, these implementations are merely examples of apparatuses and methods consistent with some aspects of the present disclosure as detailed in the appended claims.

When a lithium-ion battery is charged at a low temperature, a positive or negative electrode deintercalation rate decreases due to a decrease in ionic conductivity of an electrolyte solution, and a charging speed decreases greatly, which may even cause deposition of metal lithium at a position of a negative electrode, affecting a service life of the battery. In related technologies, there are many solutions to problems that a battery at a low temperature has a slow charging speed, and lithium deposition easily occurs for a battery at a low temperature for a long time, for example, self-exothermic heating; bidirectional pulse heating; alternating current heating; a heating method in which a battery drives an electric heating wire and cooperates with a fan for heating; and the like. However, the self-exothermic heating has low heating efficiency and slow heating generation rate. The alternating current heating affects battery aging and stability in cycling. The heating method in which a battery drives an electric heating wire and cooperates with a fan for heating has a fast heating rate, but efficiency is not high enough, and heating degree inside and outside a battery is not even. The bidirectional pulse heating is only applicable to a multi-cell system.

In view of this, in the present disclosure, based on a fact that a positive electrode plate or a negative electrode plate has a specific resistivity, if the positive electrode plate or the negative electrode plate can be energized when a battery is at a low temperature, the positive electrode plate or the negative electrode plate can heat the battery. Therefore, in the present disclosure, conduction of the positive electrode plate or the negative electrode plate is realized by disposing a preheating tab on the positive electrode plate or the negative electrode plate. Further, a controller may be disposed in the battery. When a temperature in the battery is less than a set value of battery charging, the controller controls the positive electrode plate conduct or the negative electrode plate conduct. That is, when the preheating tab is disposed on the positive electrode plate, the controller controls current to flow in from a positive tab on the positive electrode plate, and flow out from the preheating tab on the positive electrode plate to implement conduction of the positive electrode plate, so as to heat the battery. When the preheating tab is disposed on the negative electrode plate, the controller controls the current to flow in from the preheating tab, and flow out from a negative tab on the negative electrode plate to implement conduction of the negative electrode plate, so as to heat the battery. When a temperature in the battery reaches an allowed range of a charging temperature, the controller controls the current flow in from the positive tab and flow out from the negative tab to charge the battery.

The following clearly describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person of ordinary skill in the art based on the embodiments of the present disclosure without creative efforts fall within the protection scope of the present disclosure.

### Embodiment 1

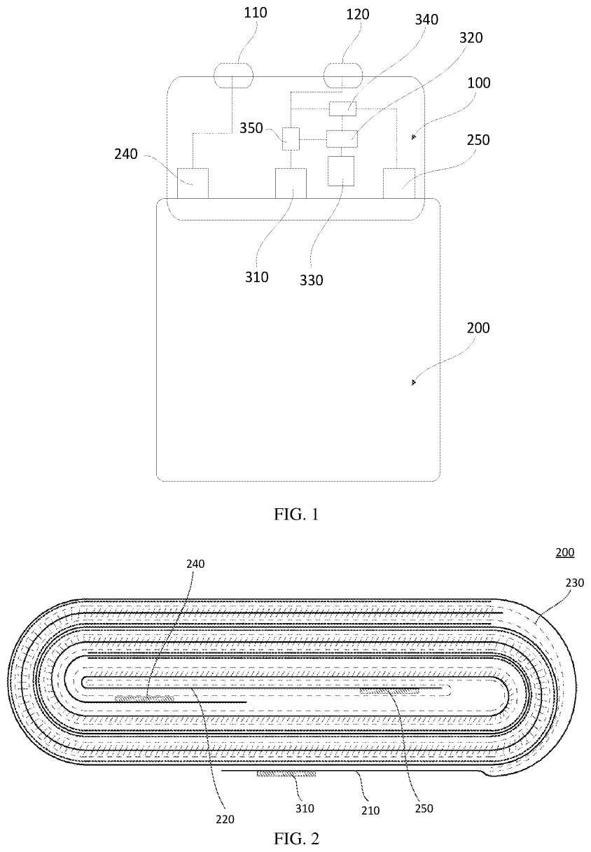

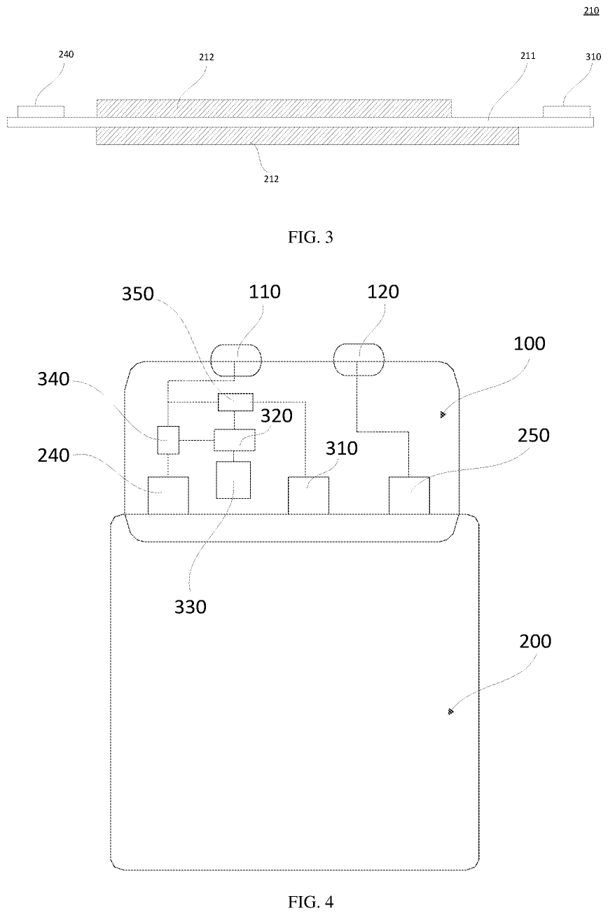

FIG. 1 is a schematic diagram of a battery according to Embodiment 1; FIG. 2 is a schematic cross-sectional diagram of a battery cell according to Embodiment 1; and FIG. 3 is a schematic cross-sectional diagram of an unwound positive electrode plate according to Embodiment 1.

As shown in FIG. 1 to FIG. 3, the battery provided in this embodiment includes a housing 100, a battery cell 200 partially disposed in the housing 100, and a preheating assembly. The battery cell 200 includes a first electrode plate, a second electrode plate, a first tab, a second tab, and a third tab. The first electrode plate may be a positive electrode plate or a negative electrode plate, and correspondingly the second electrode plate may be a negative electrode plate or a positive electrode plate. In this embodiment, the first electrode plate is a positive electrode plate 210, the second electrode plate is a negative electrode plate 220, the first tab is a positive tab 240 connected to the positive electrode plate, the second tab is the following preheating tab 310, and the third tab is a negative tab 250 connected to the negative electrode plate 220. The preheating tab 310 is connected to the positive electrode plate 210, a positive electrode 110 and a negative electrode 120 are disposed on the housing 100, and current of an external power supply flows in from the positive electrode 110 and flows out from the negative electrode 120.

As shown in FIG. 3, the positive electrode plate 210 may include an aluminum foil 211 and a positive electrode active material 212 disposed on the aluminum foil 211. As shown in FIG. 6, the negative electrode plate 220 includes a copper foil 221 and a negative electrode active material 222 disposed on the copper foil 221. Because a resistivity of the aluminum foil 211 is greater than a resistivity of the copper foil 221, in this embodiment of the present disclosure, the preheating tab 310 is preferably connected to the positive electrode plate 210.

In some possible embodiments of the present disclosure, the preheating assembly includes a preheating tab 310 and a control unit, and the control unit may include a controller 320, a charging control circuit, a heating control circuit, a detection subunit, and a temperature sensor 330. The temperature sensor 330 may be configured to collect a temperature of a tab and/or a temperature of a surface of a battery, and the tab may include at least one of a first tab, a second tab, and a third tab. The temperature sensor 330 is communicatively connected to the detection subunit, the detection subunit is communicatively connected to the controller 320, and the detection subunit transmits a battery temperature detected by the temperature sensor 330 to the controller 320, that is, the detection subunit is configured to receive the battery temperature detected by the temperature sensor 330 and feed back the battery temperature to the controller 320.

The positive tab 240 is electrically connected to the positive electrode 110 through a first circuit line, the negative tab 250 is electrically connected to the negative electrode 120 through the charging control circuit, the preheating tab 310 is electrically connected to the negative electrode 120 through the heating control circuit, and the charging control circuit and the heating control circuit are communicatively connected to the controller 320. The controller 320 controls, based on a detection value of the temperature sensor 330, opening and closing of the charging control circuit and the heating control circuit. That is, the controller 320 controls, based on the detection value of the temperature sensor 330, the charging control circuit to be closed or not to be closed, and the heating control circuit to be closed or not to be closed. The controller 320 may control the charging control circuit to be closed while controlling the heating control circuit not to be closed, may control the heating control circuit to be closed while controlling the charging control circuit not to be closed, or may control the charging control circuit and the heating control circuit to be simultaneously closed or to be simultaneously not closed. Certainly, in this embodiment of the present disclosure, a case that the charging control circuit and the heating control circuit are controlled to be simultaneously closed may not be set. However, the case that the charging control circuit and the heating control circuit are controlled to be simultaneously closed may alternatively be set as required, which is not limited herein.

In this embodiment of the present disclosure, the temperature sensor 330 may be disposed on a surface of the battery cell 200, inside the battery cell 200, or inside the housing 100. A specific location of the temperature sensor 330 is not specifically limited in this embodiment of the present disclosure.

In some embodiments of the present disclosure, when a battery in the embodiments of the present disclosure is installed in an electronic device such as a mobile phone or a tablet computer, the temperature sensor 330 and a temperature sensor in the electronic device such as a mobile phone or a tablet computer may be a same temperature sensor, that is, the temperature sensor in the electronic device such as a mobile phone or a tablet computer is used as the temperature sensor 330 in the embodiments of the present disclosure. The temperature sensor 330 in the embodiments of the present disclosure may share temperature data detected by a same temperature detector with the temperature sensor in the electronic device such as a mobile phone or a tablet computer.

The controller 320 may be separately disposed, or may be disposed on a controller of an electronic device in which the battery in the embodiments of the present disclosure is installed. When being separately disposed, the controller 320 may be located inside the housing 100 or outside the housing 100. A specific location of the controller 320 is not specifically limited in the embodiments of the present disclosure. When a battery in the embodiments of the present disclosure is installed in an electronic device such as a mobile phone or a tablet computer, the controller 320 in the embodiments of the present disclosure may be integrated with a controller in the electronic device such as a mobile phone or a tablet computer, that is, a component is added to the controller in the electronic device such as a mobile phone or a tablet computer to control heating, charging, or power-off of the battery.

In this embodiment, for a working manner of the preheating assembly, reference may be made to the following content.

When the battery is charged, the temperature sensor 330 transmits a detected temperature signal (battery temperature) to the detection subunit, and the detection subunit feeds back the battery temperature detected by the temperature sensor 330 to the controller 320. The controller 320 compares the battery temperature fed back by the detection subunit with a first temperature threshold, and the controller 320 controls, based on a comparison result, opening and closing of the charging control circuit and the heating control circuit. For a specific control process of the controller 320, reference may be made to the following content.

In some possible embodiments of the present disclosure, when a temperature detected by the temperature sensor 330 is less than the first temperature threshold, it indicates that the temperature of the battery is too low and heating needs to be performed first. In this case, the controller 320 controls the heating control circuit to be closed, and the charging control circuit is in an open state. When the heating control circuit is closed, current generated by an external power supply flows in from the positive tab 240 and flows out from the preheating tab 310, that is, the battery does not perform a charging process, and the current flows in from the positive tab 240 and flows out from the preheating tab 310 after passing through the positive electrode plate 210. The positive electrode plate 210, the positive tab 240, and the preheating tab 310 all have a specific resistance. Thermal effect generated after the resistance is energized causes the positive electrode plate 210, the positive tab 240, and the preheating tab 310 to heat the battery together, so that a temperature of the battery rapidly and uniformly increases.

Further, when the battery temperature rises to a value greater than or equal to the first temperature threshold, the charging control circuit may conduct the first electrode plate and the second electrode plate to charge the battery.

For example, in some possible embodiments of the present disclosure, when a temperature detected by the temperature sensor 330 is greater than or equal to the first temperature threshold, the controller 320 controls the heating control circuit to be open while controlling the charging control circuit to be closed. In other words, when the battery is in a heating state, and the controller 320 determines that the battery temperature is greater than or equal to the first temperature threshold, the controller controls the heating control circuit to be open and controls the charging control circuit to be closed. In this case, current generated by the external power supply flows in from the positive tab 240 and flows out from the negative tab 250, that is, the battery is charged, and the preheating assembly (the heating control circuit) stops heating the battery cell 200. In a charging process, some ohmic heat and polarization heat may also be generated in the battery, and a temperature of the battery cell 200 is always in a relatively appropriate temperature range. Therefore, when the battery is charged, it is unnecessary to continue to heat the battery cell 200, and this avoids overheating of the battery. Certainly, the heating control circuit may not be cut off, but instead, a heating power of the preheating assembly (the heating control circuit) is reduced.

The battery provided in this embodiment of the present disclosure can first heat the battery by using ohmic heat generated by energizing the first tab, the first electrode plate, and the second tab at a low temperature, and then charge the battery when a temperature inside the battery reaches a charging temperature. This may effectively solve problems that a battery at a low temperature has a slow charging speed and capacity fading, and lithium deposition easily occurs for a battery at a low temperature for a long time. In other words, the battery provided in this embodiment of the present disclosure may improve a charging speed of the battery at a low temperature, and slow down lithium deposition and capacity fading. In addition, according to the battery in the present disclosure, a battery cell may be uniformly heated in a very short time, and has high heating efficiency and good effect, which does not affect performance of the battery itself, and a production processing manner is simple.

In some embodiments of the present disclosure, a value of the first temperature threshold ranges from 5° C. to 20° C., preferably 10° C. to 15° C.

Further, in some possible embodiments of the present disclosure, when the battery is connected to an external power supply and the battery temperature is greater than or equal to a second temperature threshold, the charging control circuit and the heating control circuit are in an off state.

Certainly, in some possible embodiments of the present disclosure, the charging temperature may alternatively be set to a charging temperature range, that is, when the battery temperature is less than a minimum value of the charging temperature range, the controller 320 controls the heating control circuit to be closed, so as to heat the battery. When the battery temperature is in the charging temperature range, the controller 320 controls the charging control circuit to be closed, so as to charge the battery. When the battery temperature is greater than a maximum value of the charging temperature range, the controller 320 controls both the charging control circuit and the heating control circuit to be open. Specifically, when the temperature detected by the temperature sensor 330 is greater than the maximum value of the charging temperature range, it indicates that the temperature of the battery cell 200 is excessively high in this case. In this case, the controller 320 controls the charging control circuit and the heating control circuit to be simultaneously open, so that the battery cell 200 is not charged or heated, thereby ensuring performance and safety of the battery cell 200, and preventing adverse effects of an excessive material loss of the positive electrode 110, an increase in electrolyte consumption rate and the like caused by overheating of the battery.

In some preferred embodiments of the present disclosure, the charging temperature range may be set to 15° C.-80° C., further preferably 20° C.-30° C.

In some embodiments of the present disclosure, a low-temperature range may alternatively be set, for example, −45° C. to 15° C. In addition, to ensure safety, the low-temperature range may be adjusted by using the controller 320.

In this embodiment, the battery cell 200 further includes a separator 230 configured to separate the positive electrode plate 210 from the negative electrode plate 220. The positive electrode plate 210, the separator 230, and the negative electrode plate 220 are stacked and wound around one end thereof in a manner of one circle encircled by another. As shown in FIG. 2, the negative electrode plate 220 is wrapped by the separator 230, stacked with the positive electrode plate 210, and then wound in a structure in which one circle is encircled by another. Certainly, in this embodiment of the present disclosure, the battery cell may alternatively be in another form. As long as a preheating assembly is provided therein, a battery cell in another form is within the protection scope of the embodiments of the present disclosure, for example, the positive electrode plate and the negative electrode plate are of a plate structure.

In some embodiments of the present disclosure, the preheating assembly further includes a first control switch 340 and a second control switch 350, and the first control switch 340 and the second control switch 350 may be respectively communicatively connected to the controller 320. In this embodiment, the first control switch 340 is disposed on the charging control circuit, and the second control switch 350 is disposed on the heating control circuit. The controller 320 controls, based on a detection value of the temperature sensor 330, on and off of the first control switch 340 and the second control switch 350. Specifically, when a temperature detected by the temperature sensor 330 is less than a minimum value of a threshold range (for example, a charging temperature range), the controller 320 controls the second control switch 350 to be closed to heat the battery cell 200, and controls the first control switch 340 to be in an open state. When a temperature detected by the temperature sensor 330 is in the threshold range, the controller 320 controls the second control switch 350 to be open, and controls the first control switch 340 to be closed to charge the battery cell 200. When a temperature detected by the temperature sensor 330 is greater than a maximum value of the threshold range, the controller 320 may control the first control switch 340 and the second control switch 350 to be open simultaneously to protect the battery cell 200.

Further, the first control switch 340 and the second control switch 350 are preferably Metal Oxide Semiconductor (MOS) transistors. Certainly, the first control switch 340 and the second control switch 350 may alternatively be selected from another element that has a switch function, such as a relay.

In some possible embodiments of the present disclosure, the charging control circuit and the heating control circuit are directly connected to the controller 320, and the controller 320 directly controls opening and closing of the charging control circuit and the heating control circuit.

In this embodiment, the preheating tab 310 and the positive tab 240 are respectively disposed at two ends of the positive electrode plate 210 in a winding direction. The longer the positive electrode plate 210 between the preheating tab 310 and the positive tab 240, the greater a resistance corresponding to a portion, located between the preheating tab 310 and the positive tab 240, of the positive electrode plate 210, so that more ohmic heat is generated, and a better heating effect is obtained. Therefore, in this embodiment, the preheating tab 310 and the positive tab 240 are respectively disposed at two ends of the positive electrode plate 210 in the winding direction; or certainly, may be disposed at another position on the positive electrode plate 210.

Further, a resistance R corresponding to a portion, located between the preheating tab 310 and the positive tab 240, of the positive electrode plate 210 is greater than or equal to 4 milliohms, further preferably, R≥10 milliohms. Because if R is too small, a preheating speed of the battery cell 200 is too slow, and a current requirement of rapid charging for a battery cannot be met. In addition, because a length of the positive electrode plate 210 is limited, R is not excessively large, that is, an instantaneous heating condition does not occur.

When R=15 mΩ, and according to a power calculation formula, when a constant current of 20 A is introduced between the positive tab 240 and the preheating tab 310, the positive electrode plate 210 has an ohmic thermal power of P=I²R=6 W, and such heat level is enough to enable a small-scale consumer battery to be rapidly heated up in a short time to a temperature range suitable for rapid charging.

In some preferred embodiments of the present disclosure, the positive tab 240, the negative tab 250, and the preheating tab 310 are all of a sheet-like structure. The preheating tab 310 and the positive tab 240 do not overlap in a direction perpendicular to the positive tab 240. In other words, a jelly roll structure is formed after the positive electrode plate 210, the separator 230, and the negative electrode plate 220 are stacked and wound. A cross-section of the jelly roll structure is a long circular winding structure in which one circle is encircled by another. A width direction of the cross-section of the jelly roll structure is a thickness direction of the battery cell, and a direction perpendicular to the positive tab 240 is the same as the thickness direction of the battery cell. An arrangement in which the preheating tab 310 and the positive tab 240 do not overlap in the direction perpendicular to the positive tab 240 may reduce an increase in a thickness of the battery cell 200 caused by an increase of a tab. In addition, due to more heat generated at a position of a tab, such arrangement may avoid excessive concentration of heat generation.

Further, a sum of a resistance of a position where the preheating tab 310 and the positive electrode plate 210 are connected and a resistance of a position where the positive tab 240 and the positive electrode plate 210 are connected is R1, and a resistance corresponding to a portion, located between the preheating tab 310 and the positive tab 240, of the positive electrode plate 210 is R. To avoid heat concentration at a position where a tab is located, a relationship between R1 and R is as follows: R1/R≤40%.

R is proportional to a length of an electrode plate between the two tabs. When the length of the electrode plate increases, R increases linearly. Therefore, adjustment of a heating region and a heating power may be implemented by adjusting a distance between the preheating tab 310 and the positive tab 240.

Still further, the preheating tab 310, the positive tab 240, and the negative tab 250 do not overlap in a direction perpendicular to the positive tab 240. In other words, projections of the preheating tab 310, the positive tab 240, and the negative tab 250 in a thickness direction of the battery do not overlap. Such arrangement may reduce an increase in a thickness of the battery cell 200 caused by an increase of a tab.

In some preferred embodiments of the present disclosure, to satisfy consistency and rapidity of heating, a relationship between a distance L between a center point of the preheating tab 310 and a center point of the positive tab 240 and a width d of the positive electrode plate 210 is L≥d, preferably L≥2d.

It should be noted that in this embodiment of the present disclosure, a preheating circuit (the heating control circuit) includes only two set of tabs, namely, the positive tab 240 and the preheating tab 310. However, in this embodiment of the present disclosure, a quantity of tabs in a charging circuit (the charging control circuit) is not limited. There may be double tabs, three tabs or even N tabs in the charging circuit, where N is a positive integer greater than 2. In other words, in this embodiment of the present disclosure, after the positive electrode plate 210, the separator 230, and the negative electrode plate 220 are wound in sequence, a battery cell 200 including one preheating tab 310, at least one positive tab 240, and at least one negative tab 250 is obtained.

In some embodiments of the present disclosure, the controller is further configured to acquire a battery capacity. When the acquired battery capacity is greater than or equal to a first capacity threshold, the controller controls the charging control circuit and the heating control circuit to be open. In this embodiment, the first capacity threshold ranges from 95% to 100%.

### Embodiment 2

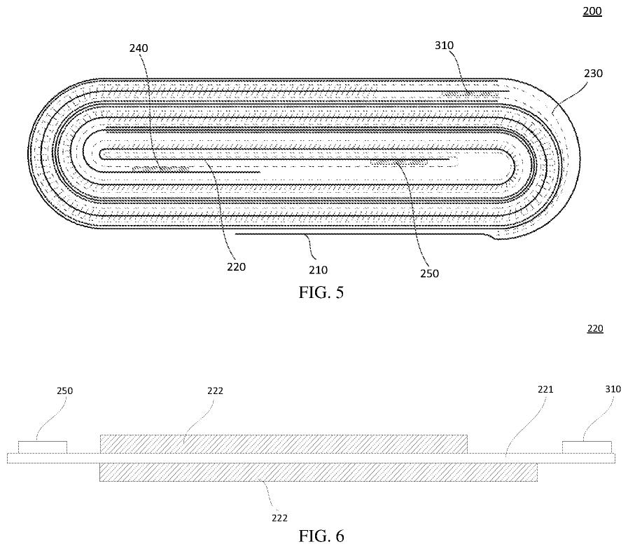

FIG. 4 is a schematic diagram of a battery according to Embodiment 2; FIG. 5 is a schematic cross-sectional diagram of a battery cell according to Embodiment 2; and FIG. 6 is a schematic cross-sectional diagram of an unwound negative electrode plate according to Embodiment 2.

As shown in FIG. 4 to FIG. 6, a structure of a battery in this embodiment is substantially the same as that of the battery in Embodiment 1, and a difference lies in that: a first electrode plate is a negative electrode plate 220, a second electrode plate is a positive electrode plate 210, a first tab is a negative tab 250 connected to the negative electrode plate 220, a second tab is a preheating tab 310, and a third tab is a positive tab 240 connected to the positive electrode plate 210. The preheating tab 310 is connected to the negative electrode plate 220. However, a working principle of a preheating assembly in this embodiment is the same as that of the preheating assembly in Embodiment 1.

Specifically, when the preheating tab 310 is connected to the negative electrode plate 220, the positive tab 240 is electrically connected to a positive electrode 110 through a charging control circuit, the negative tab 250 is electrically connected to a negative electrode 120 through a second circuit line, the preheating tab 310 is electrically connected to the positive electrode 110 through a heating control circuit, and the charging control circuit and the heating control circuit are communicatively connected to the controller 320 separately. The controller 320 controls, based on a detection value of a temperature sensor 330, opening and closing of the charging control circuit and the heating control circuit.

Similarly, in this embodiment, the temperature sensor 330 may be disposed on a surface of a battery cell 200, inside the battery cell 200, or inside a housing 100. A specific location of the temperature sensor 330 is not specifically limited in this embodiment.

In some embodiments of the present disclosure, when a battery in the embodiments of the present disclosure is installed in an electronic device such as a mobile phone or a tablet computer, the temperature sensor 330 and a temperature sensor in the electronic device such as a mobile phone or a tablet computer may be a same temperature sensor, that is, the temperature sensor in the electronic device such as a mobile phone or a tablet computer is used as the temperature sensor 330 in the embodiments of the present disclosure. The temperature sensor 330 in the embodiments of the present disclosure may share temperature data detected by a same temperature detector with the temperature sensor in the electronic device such as a mobile phone or a tablet computer.

The controller 320 may be separately disposed, or may be disposed on a controller of an electronic device in which the battery in the embodiments of the present disclosure is installed. When being separately disposed, the controller 320 may be located inside the housing 100 or outside the housing 100. A specific location of the controller 320 is not specifically limited in the embodiments of the present disclosure. When a battery in the embodiments of the present disclosure is installed in an electronic device such as a mobile phone or a tablet computer, the controller 320 in the embodiments of the present disclosure may be integrated with a controller in the electronic device such as a mobile phone or a tablet computer, that is, a component is added to the controller in the electronic device such as a mobile phone or a tablet computer to control heating, charging, or power-off of the battery.

In this embodiment, a working manner of the preheating assembly is the same as that of the preheating assembly in Embodiment 1. For a specific working manner of the preheating assembly, reference may be made to the following content.

In some possible embodiments of the present disclosure, when a temperature detected by the temperature sensor 330 is less than a first temperature threshold, the controller 320 controls the heating control circuit to be closed, and the charging control circuit is in an open state. When the heating control circuit is closed, current generated by an external power supply flows in from the preheating tab 310 and flows out from the negative tab 250, that is, the battery does not perform a charging process, and the current flows in from the preheating tab 310 and flows out from the negative tab 250 after passing through the negative electrode plate 220, thereby implementing battery heating.

In some possible embodiments of the present disclosure, when a temperature detected by the temperature sensor 330 is greater than or equal to the first temperature threshold, the controller 320 controls the heating control circuit to be open while controlling the charging control circuit to be closed. In this case, current generated by the external power supply flows in from the positive tab 240 and flows out from the negative tab 250, that is, the battery is charged, and the preheating assembly (the heating control circuit) stops heating the battery cell 200. Certainly, the heating control circuit may not be cut off, but instead, a heating power of a heating circuit line (the heating control circuit) may be reduced.

Similarly, in some possible embodiments of the present disclosure, the controller 320 may alternatively control the charging control circuit and the heating control circuit to be simultaneously open, that is, a charging temperature may alternatively be set to a charging temperature range. When the temperature detected by the temperature sensor 330 is greater than a maximum value of the charging temperature range, it indicates that the temperature of the battery cell 200 is excessively high in this case. In this case, the controller 320 controls the charging control circuit and the heating control circuit to be simultaneously open, so that the battery cell 200 is not charged or heated.

The battery cell 200 in this embodiment is the same as the battery cell in Embodiment 1, that is, the battery cell 200 may be formed by stacking and winding the positive electrode plate 210, the separator 230, and the negative electrode plate 220 in a manner of one circle encircled by another.

In some embodiments, the preheating assembly further includes a first control switch 340 and a second control switch 350, and the first control switch 340 and the second control switch 350 may be respectively communicatively connected to the controller 320. The first control switch 340 is disposed on the charging control circuit, and the second control switch 350 is disposed on the heating control circuit. The controller 320 controls, based on a detection value of the temperature sensor 330, on and off of the first control switch 340 and the second control switch 350. A controlling manner of the controller 320 is the same as a controlling manner in Embodiment 1, and details are not described herein again.

Further, when the preheating tab 310 is connected to the negative electrode plate 220, a structure formed when the preheating tab 310 is connected to the negative electrode plate 220 and performance of the structure are respectively the same as a structure formed when the preheating tab 310 is connected to the positive electrode plate 210 and performance of the structure.

For example, the preheating tab 310 and the negative tab 250 are respectively disposed at two ends of the negative electrode plate 220 in a winding direction.

A resistance R corresponding to a portion, located between the preheating tab 310 and the negative tab 250, of the negative electrode plate 220 is greater than or equal to 4 milliohms.

The preheating tab 310 and the negative tab 250 do not overlap in a direction perpendicular to the negative tab 250.

A sum of a resistance of a position where the preheating tab 310 and the negative electrode plate 220 are connected and a resistance of a position where the negative tab 250 and the negative electrode plate 220 are connected is R2, and a resistance corresponding to a portion, located between the preheating tab 310 and the negative tab 250, of the negative electrode plate 220 is R_{negative}. To avoid heat concentration at a position where a tab is located, a relationship between R1 and R_{negative} is as follows: R1/R_{negative}≤40%.

The preheating tab 310, the positive tab 240, and the negative tab 250 do not overlap in a direction perpendicular to the negative tab 250, that is, projections of the preheating tab 310, the positive tab 240, and the negative tab 250 in a thickness direction of the battery do not overlap.

A relationship between a distance L1 between a center point of the preheating tab 310 and a center point of the negative tab 250 and a width d1 of the negative electrode plate 220 is L1≥d1.

A specific effect of the foregoing setting is the same as that of the corresponding setting in Embodiment 1, and details are not described herein again.

### Embodiment 3

This embodiment is Comparative Example 1, and the battery in Embodiment 1 and a battery in Comparative Example 1 may be compared with each other in terms of performance.

For a manufacturing manner of the battery in Embodiment 1, reference may be made to the following content.

Preparation of a positive electrode plate: Adding lithium cobalt oxide (LiCoO₂), polyvinylidene fluoride (PVDF), and conductive carbon black (Super-P) into a dispersion machine at a mass ratio of 97.5:1.5:1, with N-methyl pyrrolidone (NMP) added as a solvent, to prepare a positive electrode slurry under high-speed stirring; and coating the positive electrode slurry on two surfaces of an aluminum foil with a thickness of 10 followed by drying, rolling, and slitting, to obtain the positive electrode plate.

Arrangement of a positive tab: Arranging a positive tab and a preheating tab respectively at the first fold of a head of the positive electrode plate and the last fold of a tail of the positive electrode plate, and using laser welding to implement a connection between the positive tab and the first fold of the head of the positive electrode plate and a connection between the preheating tab and the last fold of the tail of the positive electrode plate. After winding, the positive tab and the preheating tab do not overlap each other in a direction perpendicular to the positive tab.

Preparation of a negative electrode plate: Adding artificial graphite, styrene-butadiene rubber (SBR), sodium carboxymethyl cellulose (CMC-Na), and conductive carbon black (Super-P) into a dispersion machine at a mass ratio of 97:2:1:1, and then adding deionized water as a solvent to prepare a negative electrode slurry under high-speed stirring; and coating the negative electrode slurry on two surfaces of a copper foil with a thickness of 6 followed by drying at 105° C. and rolling, to obtain the negative electrode plate.

Arrangement of a negative tab: Arranging a negative tab at the first fold of a head of the negative electrode plate by using laser welding.

After the positive electrode plate, the negative electrode plate, and the separator with a thickness of 10 μm were stacked in sequence, winding was performed to obtain a jelly roll including the preheating tab.

The jelly roll is encapsulated by using an aluminum-plastic film, ethylene carbonate (EC), diethyl carbonate (DEC), and ethyl methyl carbonate (EMC) were injected at a volume ratio of 1:1:1, and then aging was performed by using an electrolyte solution of 1 mol/L lithium hexafluorophosphate (LiPF₆). After a specific period of time, a process of forming was performed, and then processes such as sorting were performed after an airbag was cut off, to obtain a battery cell. A capacity of the battery cell is 4,000 mAh, and a maximum charging voltage is 4.4 V.

A housing is welded at an appropriate position of the battery cell, the positive tab was connected to a positive electrode of the housing, the preheating tab, and the negative tab was connected to a negative electrode of the housing, and a controller, a temperature sensor, a first control switch, and a second control switch were correspondingly connected.

### Comparative Example 1

Differences between Comparative Example 1 and Embodiment 1 lie in that there is no preheating assembly in Comparative Example 1, and a charging process is directly performed during charging of a battery at a low temperature in Comparative Example 1.

Low-temperature charging system: A battery was discharged to 3.0 V at 1 C and then placed in a 10° C. thermostat, and left to stand for 12 hours. A heating process was first performed on the battery in Embodiment 1. A heating control circuit in a preheating assembly was started at a current of 20 A, and a battery temperature was monitored. After the battery temperature was greater than or equal to 20° C., the heating control circuit in the preheating assembly was interrupted, and a normal charging process was started. The battery was charged to a cut-off voltage at a current of 1 C, and then charged at a constant voltage of 4.4 V until a charging current was less than or equal to 0.05 C. The battery was allowed to stand for 10 minutes and then discharged at a current of 1 C until the battery voltage was less than or equal to 3.0 V. The foregoing heating and charging systems were repeated until the battery was charged and discharged for 500 cycles. A capacity retention rate of the battery was calculated after the charge and discharge for 500 cycles. The battery in Comparative Example 1 was charged and discharged in the same condition.

Battery lithium deposition: After being charged and discharged for 500 cycles, the battery was charged again to a cut-off voltage with a current of 1 C, then charged with a constant voltage until the charging current was less than or equal to 0.05 C. The battery was disassembled in a dry environment, and a surface of a negative electrode of the battery was observed to determine whether a black grey lithium deposition region occurs on a side, close to the negative electrode, of a negative electrode plate and on a side, close to the negative electrode, of a separator. The observation results are shown in Table 1.

Impedance test: An impedance between a positive tab and a preheating tab, namely, an impedance corresponding to a portion, located between the positive tab and the preheating tab, of a positive electrode plate was measured by using an internal resistance meter.

Heat generation power: A heat generation power was determined according to the formula P=I²R. The heat generation power was calculated by taking an impedance R between a positive tab and a preheating tab and a current of 20 A direct current into the formula.

Cell temperature rise rate: A temperature sensor wire was attached to a surface of a battery cell, and a time used when a temperature of the battery cell rose by 10° C. was recorded. The cell temperature rise rate is degree of temperature rise/time.

The detection results of the impedance test, the heat generation power and the cell temperature rise rate are shown in Table 2.

TABLE 1
Performance difference between batteries
in Embodiment 1 and Comparative Example 1

| | | | Capacity retention | Lithium |
|---|---|---|---|---|
| | Heating | Charge | rate after 500 | deposition |
| | time | time | cycles | or not |
| Embodiment 1 | 1 minute | 76 minutes | 87.35% | No |
| Comparative | / | 94 minutes | 74.22% | Yes |
| Example 1 | | | | |

It may be learned from Table 1 that, after a preheating assembly is added, because a temperature of a battery during charging is appropriate, a charge time of a battery cell for a battery in Embodiment 1 is greatly shortened compared with a battery in Comparative Example 1, and a capacity retention rate of the battery in Embodiment 1 after the charge and discharge for 500 cycles is far greater than that in Comparative Example 1. In addition, after disassembly, it is found that there is no obvious lithium deposition region on a surface of an electrode plate and a separator in Embodiment 1, and an appearance is good. However, after the battery in Comparative Example 1 is disassembled, it may be seen that there is a relatively obvious lithium deposition region.

TABLE 2
Heating powers and cell temperature
rise rates at different tab positions

| | | Impedance | | | |
|---|---|---|---|---|---|
| | | corresponding to a | | | |
| | | portion, located | | | |
| | Distance between | between a positive | | | |
| | two tabs on an | tab and a preheating | Heat | | Cell |
| | electrode | tab, of a positive | generation | | temperature |
| | plate/mm | electrode plate/R | power/P | | rise rate |
| 1 | 400 | 21.3 mΩ | 8.52 | W | 0.165° C./s |
| 2 | 600 | 29.1 mΩ | 11.64 | W | 0.195° C./s |
| 3 | 800 | 37.5 mΩ | 15.0 | W | 0.217° C./s |
| 4 | 1,000 | 45.4 mΩ | 18.16 | W | 0.230° C./s |
| 5 | 1,200 | 53.5 mΩ | 21.4 | W | 0.241° C./s |

It may be learned from Table 2 that, when the distance between the preheating tab and the positive tab on an electrode plate is changed, impedance R and heat generation power P between the two tabs increase linearly as the distance increases. However, because the cell temperature rise rate is affected by both heat generation and heat dissipation, the cell temperature rise rate does not increase linearly with an increase in impedance R (an increase in a distance between the preheating tab and the positive tab), but presents a marginal effect. For example, with an increase in the distance between the preheating tab and the positive tab, the cell temperature rise rate increases first, then decreases, or the cell temperature rise rate increases first, then does not change, and then decreases.

A battery processing manner in embodiments of the present disclosure is simple, a battery may be heated to an appropriate charge temperature in a very short time, and internal and external temperatures of the battery rise evenly, which has little impact on the battery. For example, battery performance is not affected, low-temperature fast charging performance of the battery may be effectively improved, and a service life of the battery is prolonged.

An embodiment of the present disclosure further provides an electronic device. The electronic device may include the battery in any one of the foregoing embodiments. Therefore, the electronic device may have beneficial effects of the foregoing battery.

For example, the electronic device includes a battery, and the battery includes a first electrode plate, a second electrode plate, a control unit, and a first tab and a second tab that are connected to the first electrode plate. The first electrode plate and the second electrode plate have opposite polarities. The control unit includes a heating control circuit, and in a case that the battery is connected to an external power supply, the heating control circuit is configured to: when a battery temperature of the battery is less than a first temperature threshold, conduct the first tab, the first electrode plate, and the second tab, so that current flowing into the battery flows through the heating control circuit, the first tab, the first electrode plate, and the second tab, to heat the battery, so that the battery is in a heating state.

Further, the electronic device further includes a controller, and the controller is configured to: when it is determined that the battery temperature is less than the first temperature threshold, control the heating control circuit to be closed. Specifically, the controller may be a controller originally disposed in the battery, or may be a controller originally disposed in the electronic device.

Further, the electronic device further includes a temperature sensor, configured to detect the battery temperature of the battery, and the controller is configured to determine, based on the battery temperature, the battery temperature is less than the first temperature threshold. Specifically, the temperature sensor may be a temperature sensor originally disposed in the battery, or may be a temperature sensor originally disposed in the electronic device.

The present disclosure is intended to cover any variations, uses, or adaptations of the present disclosure that follow the general principles of the present disclosure and include common knowledge or commonly used technical means in the art that are not disclosed herein. The specification and embodiments are merely considered exemplary, and the true scope and spirit of the present disclosure are set forth in the appended claims.

It should be understood that the present disclosure is not limited to the precise structures described above and shown in the accompanying drawings, and various modifications and changes may be made without departing from the scope thereof. The scope of the present disclosure is limited only by the appended claims.

What is claimed is:

1. A battery, comprising a first electrode plate, a second electrode plate, a control unit, and a first tab and a second tab that are connected to the first electrode plate, wherein
the first electrode plate and the second electrode plate have opposite polarities,
the control unit comprises a heating control circuit, and
in a case that the battery is connected to an external power supply, the heating control circuit is configured to: when a battery temperature of the battery is less than a first temperature threshold, conduct the first tab, the first electrode plate, and the second tab, so that current flowing into the battery flows through the heating control circuit, the first tab, the first electrode plate, and the second tab, to heat the battery, so that the battery is in a heating state.

2. The battery according to claim 1, further comprising a third tab connected to the second electrode plate, wherein
the control unit further comprises a charging control circuit, and in a case that the battery is connected to the external power supply, the charging control circuit is configured to: when the battery temperature is greater than or equal to the first temperature threshold, charge the battery; and
the charging control circuit is connected to the third tab, and is connected to at least one of the first tab and the second tab.

3. The battery according to claim 2, wherein the control unit further comprises a controller, a detection subunit connected to the controller, and a temperature sensor connected to the detection subunit;
the detection subunit is configured to: receive a battery temperature detected by the temperature sensor, and feed back the battery temperature to the controller; and
the controller is configured to determine, based on the battery temperature fed back by the detection subunit, the battery temperature is less than the first temperature threshold or greater than or equal to the first temperature threshold.

4. The battery according to claim 3, wherein the temperature sensor is configured to collect at least one of a temperature of the first tab, a temperature of the second tab, a temperature of the third tab, and a temperature of a surface of the battery.

5. The battery according to claim 3, further comprising a first control switch and a second control switch, wherein the first control switch is disposed on the charging control circuit, the second control switch is disposed on the heating control circuit, and the controller controls, based on a detection value of the temperature sensor, on and off of the first control switch and the second control switch.

6. The battery according to claim 2, wherein in a case that the battery is in the heating state, and a controller of the control unit determines that the battery temperature is greater than or equal to the first temperature threshold, the controller controls the heating control circuit to be open and the charging control circuit to be closed.

7. The battery according to claim 2, wherein a controller of the control unit is configured to acquire a battery capacity; and
when the battery capacity is greater than or equal to a first capacity threshold, the controller controls the charging control circuit and the heating control circuit to be open.

8. The battery according to claim 7, wherein a value of the first capacity threshold ranges from 95% to 100%.

9. The battery according to claim 2, wherein when the battery is connected to the external power supply and the battery temperature is greater than or equal to a second temperature threshold, the charging control circuit and the heating control circuit are in an off state.

10. The battery according to claim 2, wherein a charging temperature for charging the battery by the charging control circuit ranges from 15° C. to 80° C.

11. The battery according to claim 2, wherein projections of the first tab, the second tab, and the third tab in a thickness direction of the battery do not overlap.

12. The battery according to claim 1, wherein projections of the first tab and the second tab in a thickness direction of the battery do not overlap.

13. The battery according to claim 1, wherein a resistance corresponding to a portion, located between the first tab and the second tab, of the first electrode plate is greater than or equal to 4 milliohms.

14. The battery according to claim 13, wherein a sum of a resistance of a position where the first tab and the first electrode plate are connected and a resistance of a position where the second tab and the first electrode plate are connected is R1; and
the resistance corresponding to the portion, located between the first tab and the second tab, of the first electrode plate is R, wherein R1/R≤40%.

15. The battery according to claim 1, wherein a value of the first temperature threshold ranges from 5° C. to 20° C.

16. The battery according to claim 1, wherein the first tab and the second tab are respectively disposed at two ends of the first electrode plate.

17. The battery according to claim 1, wherein a relationship between a distance L between a center point of the first tab and a center point of the second tab and a width d of the first electrode plate is L≥d.

18. An electronic device, comprising a battery, wherein the battery comprises a first electrode plate, a second electrode plate, a control unit, and a first tab and a second tab that are connected to the first electrode plate,
the first electrode plate and the second electrode plate have opposite polarities, the control unit comprises a heating control circuit, and
in a case that the battery is connected to an external power supply, the heating control circuit is configured to: when a battery temperature of the battery is less than a first temperature threshold, conduct the first tab, the first electrode plate, and the second tab, so that current flowing into the battery flows through the heating control circuit, the first tab, the first electrode plate, and the second tab, to heat the battery, so that the battery is in a heating state.

19. The electronic device according to claim 18, further comprising a controller,
wherein the controller is configured to: when it is determined that the battery temperature is less than the first temperature threshold, control the heating control circuit to be closed.

20. The electronic device according to claim 19, further comprising a temperature sensor, configured to detect the battery temperature of the battery, wherein the controller is configured to determine, based on the battery temperature, the battery temperature is less than the first temperature threshold.
